(19) United States
(12) Patent Application Publication
(10) Pub. No.: US 2007/0288746 A1
(43) Pub. Date: Dec. 13, 2007

(54) Method of providing key containers

(76) Inventor: Neville Robert Jones, Anna Bay (AU)

Correspondence Address: KENNETH M. FAGIN, 136 SUMMER WALK DRIVE, GAITHERSBURG, MD, 20878, US

(21) Appl. No.: 10/594,986

(22) PCT Filed: Apr. 4, 2005
(86) PCT No.: PCT/AU05/00487

§ 371 Date: Sep. 29, 2006

(30) Foreign Application Priority Data
Apr. 2, 2004 (AU) 2004901799
Mar. 7, 2005 (AU) 2005901063

(51) Int. Cl. H04L 9/00

(52) U.S. Cl. 713/156

(57) ABSTRACT

The invention relates to providing key containers, such as an encryption or a signing key container to aid the secure transmission of messages sent from a sender to a recipient. A key container directory (20) receives a request for the key container from a requestor (14, 22 or 24). The key container provider (20) provides a key container to the requestor (14, 22 or 24) that contains a cryptographic key of a gateway (14) that the message will transit and an address of the sender (22 or 24) or the recipient (22 or 24). In this way, the message may be sent or received without the sender's or receiver's specific knowledge that the gateway will or has acted as a security proxy of the other party. The sender of the message need not have prior knowledge of the address of the recipient's message gateway. The invention also concerns a key container directory, a key container and methods of receiving a key container.

### TECHNICAL FIELD

The invention relates to providing key containers, such as an encryption or a signing key container to aid the secure transmission of messages. The invention also concerns a key container directory, a key container and methods of receiving a key container.

### BACKGROUND OF THE INVENTION

E-mail is an essential business tool for the operation modern business. It provides an easily used tool for the rapid transfer of information. Such information can be exchanged between people/machine and other people/machines.

A popular protocol for transferring e-mail is the Simple Message Transport Protocol (SMTP). This protocol is the recognised standard for the transport of messages across the Internet.

SMTP, due to its simple nature, is prone to a number of security threats. Amongst these is the threat to message confidentiality. When a message is transmitted between the sender and recipient, it passes through many intermediate devices such as e-mail relays and network routers. These devices may belong to any number of third parties. Each of these parties has the opportunity to access the contents of the message. It is difficult for the sender or the recipient to detect whether a third party had accessed, or copied the message.

Further threats to message security are to its authenticity, integrity and reputability. Non-authentic messages can be easily generated whereby one entity can act as another so it appears as though the message was sent by the impersonated party. It is difficult for the recipient to determine the origin of the forged message, from the message per se. Furthermore, if a message is modified en-route between the sender and recipient, the recipient will not be able to easily identify the modification thereby putting in doubt the integrity of the whole message. Finally, the sender of a message can repudiate its transmission claiming that they were not the author of the message or that the contents had been altered due to the weaknesses outlined.

To resolve these issues, extra security measures are required. Generally there are two solutions, secured networks or secured messages. In the first, messages can be exchanged on secure networks, whereby confidentiality, authenticity, integrity and non-repudiation are assured to some degree by characteristics of the network layout, protection mechanisms or communications protocol. No specific security additions are required for the e-mail systems on these networks, as the environment is regarded as secure. In the latter, the message itself can be secured and safely exchanged over an insecure network. This requires additional security features in the e-mail client, so that it can generate and interpret secure messages.

In general, most organisation's networks operate using the secured network philosophy. Messages between staff in a single organisation do not need extra security beyond that provided by the isolated nature of their private network.

Large organisations that routinely exchange a substantial deal of sensitive email messages will often interconnect their two networks via a private link or virtual private circuit. This link is constructed to provide a secured network path between the two organisations so the sensitive messages can travel in the clear over the secured link—the network link is regarded as being sufficiently secure to be able to protect the message contents while it is in transit between the two organisations. To put in place such links, coordinated effort and expenditure by both organisations is required and hence they are only used by larger organisations where the volume of network traffic between the two can justify the effort.

Messages that traverse the Internet and that require additional security typically use the secured message approach. This is because it is often difficult to establish secure networks between perimeter e-mail relays of sender and recipient on an ad-hoc basis; instead the sender and recipient agree on a way the message can be sent in a secured format and the intermediate e-mail systems simply deliver it as if it were a normal e-mail message.

E-mail clients capable of sending secured messages are often capable of querying Internet directory services to automatically discover the means to secure messages for a particular recipient.

With the rise in the amount of malicious content being transmitted via e-mail, many organisations are choosing to use technology at their perimeter e-mail gateways to scan inbound (and sometimes outbound) e-mail messages to ensure that items such as viruses, spam and pornographic material do not enter the network. These e-mail gateways are becoming increasingly sophisticated, but secured messages present specific challenges to them. The gateway, if it is to scan encrypted messages for prohibited content, needs to have knowledge of the secure message format being used and have the key to decrypt the message as it can be very difficult to determine whether an encrypted message has undesired content.

Pretty Good Privacy (PGP) was first developed in the early 1990s. It is a form of package security whereby an arbitrary blob of data can be secured using the application of public key cryptographic techniques. When integrated with e-mail software, PGP can simply take the content of an e-mail message as its input blob of data and secure it for the recipient of the message, using the recipient's public key to uniquely encrypt it for them.

Privacy Enhanced Mail (PEM) was proposed in the early-1990s and like PGP uses public key cryptography to secure an e-mail message.

Secure Multipart Internet Mail Extensions (S/MIME) was developed in the late 1990s and was the integration of a public key cryptosystem using trusted third parties with the MIME standard. S/MIME is based on RSA's PKCS#7 data standard.

S/MIME uses X.509 certificates for electronic authentication of remote entities. The certificate contains a public key that is used to verify digital signatures and/or encrypt messages. The certificate also contains further attributes including the same entity's name and their e-mail address.

Generally, certificates may be exchanged between parties in two ways. In the first mechanism, one party sends a signed message to the second. The signed message includes the sender's certificate(s) and the receiving party extracts it from the message and stores in an electronic e-mail address book. The second party can then use the public encryption key from the first party's certificate to generate an encrypted message for the first party. The second mechanism involves the publication of certificates in an electronic directory which is accessible to other entities. The sending party retrieves the intended recipient's certificate using a directory access protocol, e.g. Lightweight Directory Access Protocol (LDAP) or using a web application connected with HyperText Transfer Protocol (HTTP). Depending on the configuration of the directory, a party may be able to browse for certificates, or may be able to search for certificates using the recipient's e-mail address, name, organisation, etc., as a search parameter. The automatic certificate search and retrieval mechanism is often a feature of secure e-mail clients.

S/MIME has been integrated into e-mail clients such as Microsoft® Outlook®, and Lotus Notes®. It has also been implemented as a “plug-in” by third party vendors.

S/MIME has been integrated into secure e-mail gateways. E-mail gateways join e-mail networks. A secure e-mail gateway can be used to join a secure and an insecure network. On the secure network, typically the organisation's network, the message travels “in-the-clear”, as it does not require further security. On the insecure network, the message requires additional security, such as that available from S/MIME.

The secure e-mail gateway can act as a security proxy for entities on the secure network. The secure e-mail gateway should be able to sign and/or encrypt messages crossing from the secure network to insecure network, and decrypt and/or verify messages crossing from the insecure network to the secure network. Secure e-mail gateways remove the need for entities on secure networks to use and manage their own keys and encrypted e-mail which reduces costs for the organisation and relieves the end-user of much of the complexity of managing a secure e-mail network.

Secure e-mail gateways can issue proxy certificates on behalf of users on their message domain: A sender that is not local to the gateway's domain must request certificates from the sender's gateway. The request is in the form of an e-mail addressed to the recipient's gateway. To do this, the sender must be aware of the address that the request of the gateway should be addressed to and how to structure the message to illicit the correct response from the gateway, for example using a specific subject line to identify whose details should be in the proxy certificate. The gateway then responds to the request by replying with an e-mail that includes the requested certificate. The sender must then extract the certificate from the e-mail and add it to their local e-mail address book.

### SUMMARY OF THE INVENTION

In a first aspect, the invention is a method of providing a key container by a key container directory, the key container to be used to secure a message that will be sent from a sender to a recipient, the method comprising the steps of:

receiving a request for the key container from a requestor; and

in response to the request, providing a key container to the requestor that contains a cryptographic key of a gateway that the message will transit and an address of the sender or the recipient.

By providing this key container to the requester, the sender of the message is able to send the message or the recipient of the message is able to receive the message without any specific knowledge that the gateway will or has acted as a security proxy of the other party.

Since the key container is provided by a key container directory, the sender of the message need not have prior knowledge of the address of the recipient's message gateway. Further, the sender of the message need not extract the key container from an e-mail from the recipient's gateway and manually store the key container in their address book.

Since the key container contains the cryptographic key of the gateway, once the gateway receives the message it is able to perform security related operations on the message such as signing or decrypting the message. This helps to increase the security of the message as it is transmitted over one or more computer networks without increasing the complexity of sending or receiving a message securely for a sender or receiver.

The key container directory may be remote from the gateway, such as external to the network domain of the gateway. The key container directory may be external to the network domain of the recipient. The message may be transmitted from the sender over an insecure computer network, such as the Internet. The network domain of the recipient may be secure.

The step of providing a key container may comprise providing a key container for each gateway that the message will transit. The request may infer the gateway that the message will transit. The method may further comprise the step of determining the identity of one or more gateways that the message will transit. The key container directory may provide multiple key containers in the response to the request.

The step of providing a key container may comprise providing a key container that contains the genuine public key of the recipient. The genuine key container may be sourced from a localised data store of the provider, or the provider may obtain it from other known providers by real-time queries.

The requestor may be the sender of the message. The request may include the address of the recipient. The request may be received from an e-mail client of the sender.

The step of requesting the key container may include an indication that an encryption key container is requested.

The method may further comprise the step of determining what type of key container should be provided to the requester. The step of determining may include determining whether the requestor is the sender of the message, and if so, providing an encryption key container to the requestor. The step of determining may further comprise determining whether the requestor is from the same domain as the gateway, and if not, providing the encryption key container containing the cryptographic key of the recipient's gateway. The step of determining may further include determining whether the requestor is from the same domain as the gateway, and if so, providing the encryption key container having the cryptographic key of the requestor's gateway.

The requestor may be the gateway. The request may include the address of the sender.

The step of requesting the key container may include an indication that a signing key container is requested.

The method may further comprise the step of determining what type of key container should be provided to the requestor. The step of determining may further comprise determining whether the requestor is the gateway, and if so, providing the signing key container containing the cryptographic key of the gateway and the message sender's address. The sender's address may be from the same domain as the gateway.

The step of determining may be based on parameters associated with the request.

The method may further comprise the step of the requestor authenticating with the key container directory. The determining steps may be based on the information provided by the requestor when authenticating with the key container directory.

The step of authenticating may be through use of a valid username and password combination.

Once the request has been received, the method may further comprise the step of generating the requested key container. In this way, key containers can be generated when required rather than maintaining a large repository of all possible key containers.

The request may be made using a computer communication protocol, such as Lightweight Directory Access Protocol (LDAP), Directory Access Protocol (DAP), Certification Management Protocol (CMP), that of XML Key Management Specification (XKMS) or the HyperText Transfer Protocol (HTTP).

The key container may contain a cryptographic key that is a public key. The key container may be a digital certificate or a Pretty Good Privacy (PGP) public key. The digital certificate may be an X.509 digital certificate. The address may be an e-mail address and the gateway may be an e-mail gateway.

The key container may be for a specific message.

The key container may contain information that invalidates its use at a time in the future. This time may be of sufficiently short duration that the key container can only be used for one, or at least very few messages, before another key container must be obtained.

The key container may contain the same container identifiers, such as serial number and issuer name, of the key container of the gateway. This provides backwards compatible operation for those gateways which use these parameters to determine which private key to use to decrypt the message.

The key container may be an encryption key container to be used for encryption operations. The key container may contain a parameter that indicates that the key container is to be used for encryption functions. In this way, the gateway can decrypt the message when it receives it and scan the message contents as the message transits the gateway.

The key container may secure the message through use of the cryptographic key to encrypt the message.

The sender's address may be from the same domain as the gateway.

The key container may be a signing key container. The key container may contain a parameter that indicates that the key container is to be used for signing operations. In this way, the gateway can sign the message as it transits the gateway and allows the recipient of the message to use the cryptographic key to verify the signature.

The key container may secure the message by permitting the recipient to perform signature verification upon the message, such as by confirming the authenticity of the message sender and verify the message has maintained its integrity in transit.

The key container may contain security preferences of the gateway, such as Secure Multipart Internet Mail Extensions (S/MIME) Capabilities or PGP Symmetric Algorithm Preferences.

The key container may include information about the key container directory that provided the key container.

The key container may include information that permits a requestor to determine the authenticity and integrity of the key container.

In a second aspect, the invention provides a key container directory operable to provide a key container as described above, wherein the key container directory is remote from the gateway, such external to the network domain of the gateway.

The key container may have a datastore of cryptographic keys that can be contained in any provided key container.

In a third aspect, the invention is a method of receiving a key container comprising the steps of:

sending a request to a key container directory for a key container to be used to secure a message that is transmitted from a sender to a recipient; and

receiving from the key container directory the key container that contains the cryptographic key of a gateway that the message will transit and an address of the sender or the recipient.

This method may be performed by the sender of the message. The step of sending may be performed by an e-mail client of the sender.

The step of sending a request for the key container may include an indication that an encryption key container is requested. The step of sending the request for the key container may include the address of the recipient.

The method may further comprise the step of encrypting the message using the cryptographic key contained in the key container.

The key container may have some of the features described above.

This method may be performed by the gateway.

The step of sending the request for the key container may include an indication that a signing key container is requested. The step of sending the request for the key container may include the address of the sender.

The key container may have some of the features of the key container described above.

In a fourth aspect, the invention provides an e-mail client that is operable to perform the method of receiving a key container as described above.

In a fifth aspect, the invention provides a gateway that is operable to perform the method of receiving a key container as described above.

In a sixth aspect, the invention is a key container to be used to secure a message that is transmitted from a sender to a recipient using a gateway, wherein the key container contains a cryptographic key of the gateway, an address of the sender or the recipient and information that invalidates the use of the key container at a time in the future.

The key container may have any one or more of the features described above.

It is an advantage of at least one embodiment of the invention that the sender may consider that they have constructed an e-mail that is addressed to the recipient and will be decrypted by them. They do not, nor does their e-mail client require any knowledge of the gateway. The sender is only required to trust the key container issued by the key container directory.

It is an advantage of at least one embodiment of the invention that it is backwards compatible with a wide range of existing e-mail clients.

It is an advantage of at least one embodiment of the invention that by enabling a gateway to decrypt or sign a message on behalf of the sender or recipients they do not require personal private/public key pairs, nor certificates.

It is a further advantage of at least one embodiment of the invention that a sufficiently advanced secure e-mail gateway that is capable of both decrypting S/MIME and PGP encrypted messages or creating S/MIME or PGP signatures can use the same private and public key pair for both encryption and signing security operations thereby alleviating additional key management overhead, if so desired.

It is an advantage of at least one embodiment of the invention that by enabling the gateway to decrypt messages, the gateway is able to archive clear text messages. This removes the need for key archiving.

It is an advantage of at least one embodiment of the invention that it prevents e-mail harvesting which in turn reduces spam e-mails. The key container directory will always return a key container for any e-mail address belonging to a domain for which it has the gateway's cryptographic key. This does not indicate or imply that the e-mail address corresponds to a valid mailbox in the domain. In conventional directory services if a certificate is returned for a guessed e-mail address this indicates to a spammer that the address is most likely real and so they can harvest addresses by performing extensive searches or by browsing the directory.

It is an advantage of at least one embodiment of the invention that for any new staff that join an organisation there is no additional work beyond allocating them a mailbox and e-mail address on the internal mail system to allow them to receive encrypted messages from external parties or send signed e-mails. This reduces the overhead of adding secure e-mail capabilities for new staff.

It is an advantage of at least one embodiment of the invention that group shared mailboxes, aliases and the like are also able to receive encrypted e-mail as the key container directory will provide key containers with these addresses contained in them.

It is an advantage of at least one embodiment of the invention that the organisation's email security is centralised by using the key container directory. The organisation can reduce the amount of encrypted material within the network and the associated costs of managing material.

It is an advantage of at least one embodiment of the invention that the need of the directory to generate, distribute or make available revocation information about the key containers it has generated is negated by the short lifespan of the key containers. Similarly, clients who obtain key containers from the directory do not have to seek, obtain, validate and interpret the revocation information about such short lived key containers. A gateway public key that is discovered to be untrustworthy can be removed from the key directory system and it therefore cannot continue to generate key containers with that gateway public key.

It is an advantage of at least one embodiment of the invention that an organisation can frequently rekey its gateway key pair wherein a new private and public key pair are created for use by the gateway. Due to the possible short lived nature of the key containers, clients do not retain the key containers on their system and so must always obtain new key containers from the directory. The organisation can rekey its gateway key pair, supply the new gateway public key to the directory and the directory may immediately commence generating key containers with the new gateway public key contained therein. This alleviates many of the problems associated with conventional rekey events. Hence the invention allows for frequent rekeying of the gateway keys which is regarded as producing greater security, but which is an approach that is often avoided because of the problems associated with it.

It is an advantage of at least one embodiment of the invention that a sender of encrypted messages need only use a single key container directory within their e-mail client for the retrieval of key containers. The key container directory can obtain genuine key containers from a local data store or by querying the directories of other providers. Regardless, the sender's e-mail client only needs to be configured for a single key container directory to be able to obtain key containers of the proxy or genuine variety.

It is an advantage of at least one embodiment of the invention that the sending secure e-mail client may receive a set of key containers from the key container provider which can be used to encrypt the message for each interested party along the message's delivery pathway, such as sender's secure e-mail gateway, recipient's secure e-mail gateway and actual recipient. If the client uses the set to encrypt the message for all parties then the intervening gateway(s) do not have to re-encrypt the message for the next party. This saves cryptographic processing at the gateways and reduces the number of requests sent to the key container provider, thereby reducing network traffic.

### BRIEF DESCRIPTION OF THE DRAWINGS

Embodiments of the invention will now be described with reference to the following drawings, in which:

FIG. 1 is a schematic diagram of a computer system showing the use of an encryption key container to send an inbound e-mail message;

FIG. 2 is a schematic diagram of a computer system showing an alternate use of an encryption key container to send an outbound e-mail message;

FIG. 3 is a schematic diagram of a computer system, showing the use of a signing key container to send an e-mail message; and

FIG. 4 is a sequence diagram depicting the operation of a key container directory.

### BEST MODES OF THE INVENTION

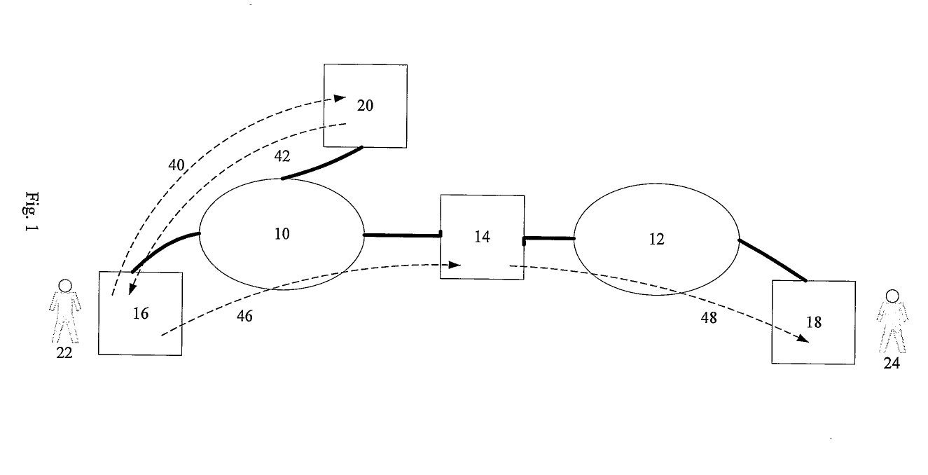

Referring to FIG. 1, the components of the a computer system that can send a message from a sender to a receiver using the invention.

A first network is shown at 10 that is an insecure network. To transmit a sensitive message over this insecure network 10 additional levels of security, such as digital signatures and encryption, are required before a message transmitted on this network can be considered authentic and confidential.

A second network is shown at 12 which is a secure network. Clear text messages on this secure network 12 require no further security. Threats to message confidentiality and authenticity within this network 12 are treated as low risk.

A secure e-mail gateway as shown at 14 bridges the insecure 10 and secure 12 networks. The gateway 14 is the domain gateway for the message domain 12. The secure e-mail gateway 14 has a public/private key pair used for message signing, and a public/private key pair for message encryption. The same key pair may be used for signing and encryption. The secure e-mail gateway 14 is capable of performing requests for key containers against the key container directory 20.

A secure e-mail client on the insecure network 10 is shown at 16. The secure e-mail client 16 has the capability to encrypt and decrypt messages, to sign and verify messages and perform requests for key containers against the key container directory 20.

An e-mail client on the secure network 12 is shown at 18. This e-mail client 18 is not necessarily a secure e-mail client.

A key container directory, such as a certificate directory service is shown at 20. This directory 20 is trusted by the secure e-mail client 16. The directory 20 is able to produce key containers on behalf of entities on the computer network. The directory 20 has access to or has stored the e-mail gateway's 14 public signing key and public encryption key. The directory is remote from the networks 10 and 12.

An alternative deployment may replace the secure e-mail client 16 with a further secure e-mail gateway that bridges the insecure network 10 with a further secure network (not shown).

A further alternative deployment may add further directories (not shown) on the insecure network 10 that the directory 20 can access.

Intrinsic to the e-mail network are e-mail servers, e-mail relays and domain name servers. These are used to transport, and assist the transport of, the message from the sender to the recipient. For simplicity the invention is described without these conventional components.

A user (the sender) 22 on the insecure network 10 wishes to send a message to a user (recipient) 24 on the secure network 12. The user 22 wishes to ensure the contents of the message remains confidential, at least while in transit over the insecure network 10. Referring also to FIG. 1 the method for sending this inbound message will now be described.

The user 22 generates the message using the secure e-mail client 16 on the insecure network 10. The user 22 specifies at the e-mail client 16 the recipient's e-mail address and specifies that the message is to be encrypted.

Prior to transmission, the secure e-mail client 16 performs an authenticated request 40 (an unauthenticated/anonymous request is regarded as a special case of authenticated request) against the directory 20 for the public key container(s) of the user 24.

The directory 20 determines that the request has originated from an e-mail client 16 that is external to user 24's message domain. The directory 20 generates an encryption key container in response. This key container embeds the public key of user 24's secure e-mail gateway 14 and the e-mail address of the user 24.

This key container is then transmitted 42 to the secure e-mail client 16. The secure e-mail client 16 verifies the integrity and authenticity of the key container and if satisfied it has been generated from a trustworthy source then uses the public key from the received key container to encrypt the message. The e-mail client 16 may or may not be aware that the key container received does not contain the public key specific to the user 24.

The secure e-mail client 16 then transmits 46 the encrypted message to the user (recipient) 24. The mail system on the insecure network 10 routes this encrypted message to the secure e-mail gateway 14.

The secure e-mail gateway 14 decrypts the message using its private decryption key. The secure e-mail gateway 14 can now perform any content analysis tasks required.

This decrypted message is then transmitted 48 by the e-mail gateway 14 to the user 24. The mail system on the secure network 12 routes the message to the user's 24 e-mail client 18. The user 24 then retrieves the message using the mail client 18 and reads the message.

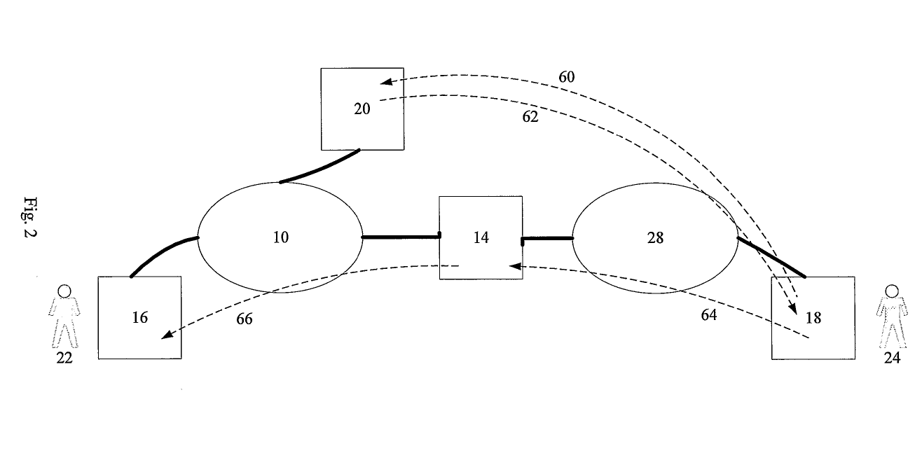

With reference to FIG. 2 a further embodiment of the invention will now be described. The same reference numerals as those in FIG. 1 are used in FIG. 2 to represent the same components of the computer network.

In this embodiment the user 24 (now the sender) on the network 28 wishes to send an outbound message to a user 22 (now the recipient) on the insecure network 10. The user 24 wishes to ensure the contents of the message remains confidential, even while in transit over the network 28 which may be secure or insecure. If the network 28 is secure the sender may require further security than that which is provided on the network 28.

The user 24 generates the message using the secure e-mail client 18 on the network 28. The user 24 specifies at the e-mail client 18 the user's 22 e-mail address and specifies that the message is to be encrypted.

Prior to transmission, the e-mail client 18 performs an authenticated request 60 for the public key container(s) of the user 22 against the directory 20.

The directory 20 determines that the request has originated from a client within the network 28 and then generates an encryption key container in response. This key container embeds the secure e-mail gateway's 14 public encryption key and the user's 22 e-mail address. This key container is transmitted 62 to the e-mail client 18.

The e-mail client 18 may or may not be aware that the key container it received does not contain the public key of the user 22. The e-mail client 18 verifies the integrity and authenticity of the key container and if satisfied it has been generated from a trustworthy source then uses the public key embedded within the received key container to encrypt the message.

The secure e-mail client 18 then transmits 64 the encrypted message to the user 22. The mail system on the network 28 routes the message to the secure e-mail gateway 14.

The secure e-mail gateway 14 decrypts the message using its private decryption key and performs any content analysis tasks required.

The secure e-mail gateway 14 then transmits the message to the user 22. The message may be transmitted in this decrypted state. Alternatively, the secure e-mail gateway 14 can re-encrypt the message using the user's 22 genuine public key.

The mail system on the insecure network 10 routes the message to the user's 22 email client 16. The user 22 can then retrieve and read the message.

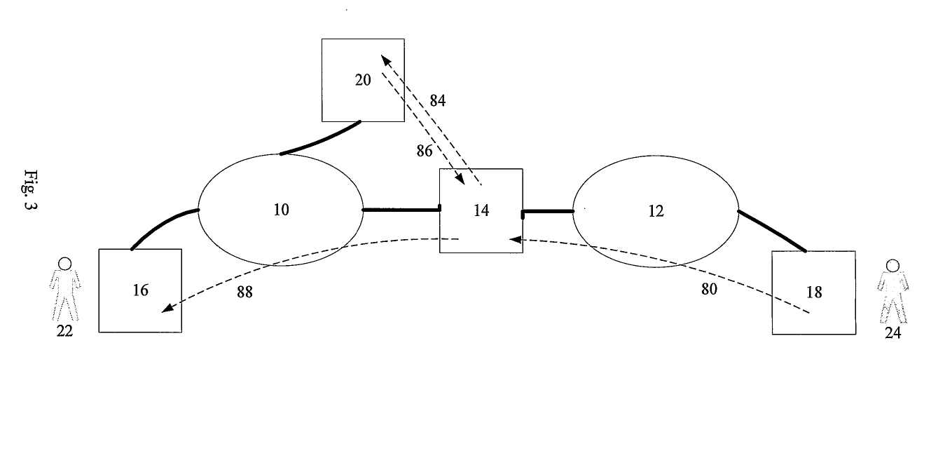

A further embodiment of the invention will now be described with reference to FIG. 3. Similarly, the same reference numerals as those in FIG. 1 are used in FIG. 3 to represent the same components of the computer network.

In this embodiment the user 24 (the sender) on the secure network 12 wishes to send a message to a user 22 (the recipient) on the insecure network 10. The user 24 wishes the user 22 to be able to verify the message has originated from the user's 22 message domain and to be assured that it has retained its integrity while in transit over the insecure network 10.

The user 24 generates the message using the e-mail client 18 on the secure network 12. The user 24 specifies the user's 22 e-mail address and transmits 80 the message to the user 22. The user 24 also indicates that the message should retain its authenticity and integrity while on the insecure network 10. The user 24 may make this indication by including in the subject line of the e-mail a predetermined string of characters or selecting the option within the e-mail client, such as ticking a check box. The mail system on the secure network 12 routes the message to the secure e-mail gateway 14.

The secure e-mail gateway 14 signs the message with its private signing key. It performs an authenticated request 84 against the directory 20 for the public key container(s) of the user 24.

The directory 20 determines that the request has originated from the user 24 domain's secure e-mail gateway 14 and in consequence generates a signing public key container in response. This key container embeds the secure e-mail gateway's 14 public signing key and the sender's e-mail address, and a parameter that indicates the container is for use with digital signature operations. The directory 20 then transmits 86 the key container to the secure e-mail gateway 14.

The secure e-mail gateway 14 embeds the key container within the signed message that has been created with the private signing key. The secure e-mail gateway 14 transmits 88 the message and the signing public key container to the user 22 across the insecure network 10.

The user 22 retrieves the message using the secure e-mail client 16 on the insecure network 10. The secure e-mail client 16 verifies the authenticity and integrity of the message by performing a digital signature verification operation.

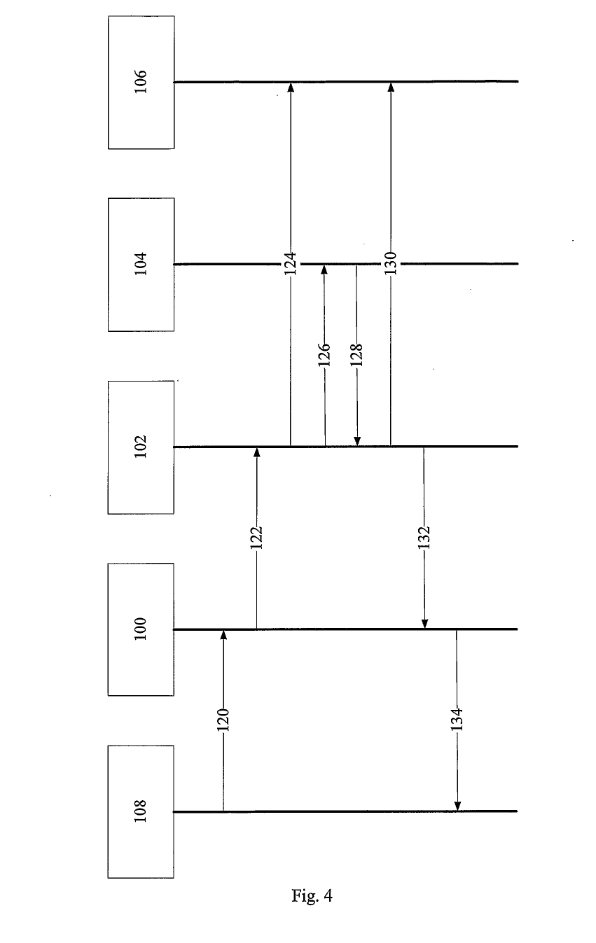

Referring now to FIG. 4 the subcomponents of the directory 20 will now be described which are:

A directory access interface 100;

A controller 102;

A certification authority, with private signing key 104; and

A database or data store 106, which stores gateway public keys and caches generated public key containers.

A requester 108 initiates the provision of public key containers. The requester 108 could be a secure e-mail gateway 12 or a secure e-mail client 16.

The operation of the directory 20 will now be described with reference to FIG. 4. For simplicity the provision of a single public key container in response to a request is described, however generation of multiple containers for various purposes in response to a single request is also possible.

It is also possible that the directory may query the directories of other providers and retrieve the genuine key container of the recipient. These other providers may be conventional certificate directories or may be PGP public key servers. The genuine key container may be part of the set of key containers that is provided to the requestor based on a single request The requesting client 108 requests 120 a key container from the directory 20 via the directory access interface 100. The request may contain information that can be used to authenticate the requester to the directory 20, or the request is being made within a session context wherein the requestor earlier authenticated themselves. The requestor 108 then specifies the entity for which it requires key container(s) by supplying the entity's e-mail address. The search request contains information about what type of key container is required by the client (either X.509 certificate or PGP public key).

The directory access interface 100 notifies 122 the controller 102 of the request, including the entity's e-mail address, the authentication credentials of the requesting client and the type of key container that is required. The controller 102 determines the origin of the request by comparing the presented authentication credentials with a known, allocated sets of credentials. Anonymous requests are deemed to originate from clients on the insecure network 10 while authenticated requests may either originate from clients within the secure network 12 or from the gateway itself 14. To distinguish the two, the clients within the secure network use different credentials to those used by the e-mail gateway 14. The controller 102 knows the destination domain based on the e-mail address in the search and hence can determine the e-mail gateway(s) that will be traversed by an e-mail message going from origin to destination. From this knowledge it can decide which form of key container to construct, either an encryption key container (either inbound or outbound) or a signing key container or if to obtain a genuine key container from another directory.

If the controller has determined that it is to return an encryption key container for an inbound message (see FIG. 1) then it uses the domain information from the e-mail address (recipient's email address) in the client search request as a parameter to retrieve the recipient's domain gateway's public key from the trusted database 106.

If the controller 102 has determined that it is to return an encryption key container for an outbound message (see FIG. 2) or a signing key container (see FIG. 3) then it uses the domain information associated with the request's origin (either domain user or domain gateway) as a parameter to retrieve the domain gateway's public key from the trusted database 106. Alternatively, the controller retrieves the e-mail gateway's key container from another directory or database, verifies the authenticity of the gateway's public key container and extracts the public key.

The controller 102 then generates 126 a key container using the certification authority 104. It specifies the public key as retrieved, the e-mail address of the requested entity and the type of key container to create. It may optionally add details of the e-mail security preferences of the gateway to the container. The certification authority 104 shall set the expiry date and time of the key container based on knowledge of the current date and time and the required lifetime of the key container.

The certification authority 104 returns 128 the generated key container to the controller 102.

The controller 102 optionally stores 130 the generated key container in the database 106.

The controller 102 then returns 132 the generated key container to the directory access interface 100.

The interface 100 then returns 134 the generated key container to the requesting client 108.

The preferred implementation formats, interfaces and protocols will now be described.

The request between secure e-mail gateway 14 and key container directory 20 uses LDAP version 3 protocol. The requestor authenticates to the directory using username and password exchange during the LDAP bind operation.

Message transmission protocol is SMTP.

Message security is provided with S/MIME version 3.

Public key containers are X.509 version 3 certificates.

Message digest is SHA-1.

Message encryption is 3DES.

E-mail security preferences returned in the X.509 certificates consist of the appropriate standard Key Usage (KeyUsage=digitalSignature and/or keyEncipherment or keyAgreement) and Extended Key Usage (KeyPurposeld=id-kp-e-mailProtection) extensions, and optionally the S/MIME Capabilities private extension.

E-mail client is Microsoft Outlook Express 6, operating on a Microsoft Windows XP platform.

Secure e-mail client 16 is Microsoft Outlook Express 6, operating on a Microsoft Windows XP platform. It uses a 1024 bit RSA private/public key pair. The public key is embedded in an X.509 certificate generated by OpenSSL.

Secure e-mail gateway 14 is Clearswift MAILsweeper 5.0 integrated with SSS SecurelT S/MIME component. The secure e-mail gateway 14 operates on Microsoft Windows 2000 Server on an Intel Pentium 4 platform. It uses a 1024 bit RSA private/public key pair. The public key is embedded in an X.509 certificate generated by OpenSSL.

The directory 20 is built using the Bouncy Castle Crypto package on the Java Standard Development Kit 1.4.2 for the Certification Authority, OpenLDAP 2.2.8 for the directory access interface and mySQL 4.0.18 for the database. It operates using the Gentoo Linux 2004.3 operating system on an Intel Pentium 4 platform.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of providing a key container by a key container directory, the key container to be used to secure a message that will be sent from a sender to a recipient, the method comprising the steps of:
receiving a request for the key container from a requestor; and
in response to the request, providing a key container to the requester that contains a cryptographic key of a gateway that the message will transit and an address of the sender or the recipient.

2. A method of providing a key container according to claim 1, wherein the key container directory is remote from the gateway, such as external to the network domain of the gateway.

3. A method of providing a key container according to claim 1, wherein the key container directory is external to the network domain of the recipient.

4. A method of providing a key container according to claim 1, wherein the message is transmitted from the sender over an insecure computer network, such as the Internet.

5. A method of providing a key container according to claim 1, wherein the network domain of the recipient is secure.

6. A method of providing a key container claim 1, wherein the step of providing a key container comprises providing a key container for each gateway that the message will transit.

7. A method of providing a key container according to claim 1, wherein the method further comprises the step of determining the identity of one or more gateways that the message will transit.

8. A method of providing a key container according to claim 1, wherein the key container directory provides multiple key containers in the response to the request.

9. A method of providing a key container according to claim 1, wherein the requester is the sender of the message and the request includes the address of the recipient.

10. A method of providing a key container according to claim 9, wherein the step of requesting the key container includes an indication that an encryption key container is requested.

11. A method of providing a key container according to claim 9, wherein the method further comprises the step of determining what type of key container should be provided to the requestor.

12. A method of providing a key container according to claims 11, wherein the step of determining comprises determining whether the requestor is the sender of the message, and if so, providing an encryption key container to the requester.

13. A method of providing a key container according to claim 11, wherein the step of determining further comprises determining whether the requestor is from the same domain as the gateway, and if not, providing the encryption key container containing the cryptographic key of the recipient's gateway.

14. A method of providing a key container according to claim 11, wherein the step of determining further comprises determining whether the requestor is from the same domain as the gateway, and if so, providing the encryption key container having the cryptographic key of the requestor's gateway.

15. A method of providing a key container according to claim 1, wherein the requestor is the gateway and the request includes the address of the sender.

16. A method of providing a key container according to claim 1, wherein the step of requesting the key container includes an indication that a signing key container is requested.

17. A method of providing a key container according to claim 1, wherein the method further comprises the step of determining what type of key container should be provided to the requester.

18. A method of providing a key container according to claim 17, wherein the step of determining further comprises determining whether the requestor is the gateway, and if so, providing the signing key container containing the cryptographic key of the gateway and the message sender's address.

19. A method of providing a key container according to claim 18, wherein the sender's address is from the same domain as the gateway.

20. A method of providing a key container according to claim 11, wherein the step of determining is based on parameters associated with the request.

21. A method of providing a key container according to claim 1, wherein the method further comprises the step of the requestor authenticating with the key container directory.

22. A method of providing a key container according to claim 21, wherein the method further comprises the step of the requestor authenticating with the key container directory and the step of determining is based on the information provided by the requestor when authenticating with the key container directory.

23. A method of providing a key container according to claim 21, wherein the step of authenticating is through the use of a valid username and password combination.

24. A method of providing a key container according to claim 1, wherein once the request has been received, the method further comprises the step of generating the requested key container.

25. A method of providing a key container according to claim 1, wherein the request is made using a computer communication protocol selected from the group consisting of Lightweight Directory Access Protocol (LDAP), Directory Access Protocol (DAP), Certification Management Protocol (CMP), XML Key Management Specification (XKMS), and HyperText Transfer Protocol (HTTP).

26. A method of providing a key container according to claim 1, wherein the key container contains a cryptographic key that is a public key.

27. A method of providing a key container according to claim 1, wherein the key container is a digital certificate.

28. A method of providing a key container according to claim 1, wherein the key container is a Pretty Good Privacy (PGP) public key.

29. A method of providing a key container according to claim 1, wherein the address contained in the key container is an e-mail address and the gateway is an e-mail gateway.

30. A method of providing a key container according to claim 1, wherein the key container is provided for a specific message.

31. A method of providing a key container according to claim 1, wherein the key container contains information that invalidates its use at a time in the future.

32. A method of providing a key container according to claim 31, wherein the time is of sufficiently short duration that the key container can be used for only a few messages.

33. A method of providing a key container according to claim 1, wherein the key container contains the same container identifiers of the key container of the gateway.

34. A method of providing a key container according to claim 1, wherein the key container is an encryption key container to be used for encryption operations.

35. A method of providing a key container according to claim 34, wherein the key container contains a parameter that indicates that the key container is to be used for encryption functions.

36. A method of providing a key container according to claim 1, wherein the key container secures the message through use of the cryptographic key to encrypt the message.

37. A method of providing a key container according to claim 1, wherein the sender's address is from the same domain as the gateway.

38. A method of providing a key container according to claim 1, wherein the key container is a signing key container.

39. A method of providing a key container according to claim 1, wherein the key container contains a parameter that indicates that the key container is to be used for signing operations.

40. A method of providing a key container according to claim 1, wherein the key container secures the message by being carried with the message.

41. A method of providing a key container according to claim 1, wherein the key container includes information that permits a requestor to determine the authenticity and integrity of the key container.

42. A method of providing a key container according to claim 1, wherein the key container contains security preferences of the gateway.

43. A method of providing a key container according to claim 1, wherein the key container includes information about the key container directory that provided the key container.

44. A key container directory operable to provide a key container according to the method of claim 1, wherein the key container directory is remote from the gateway.

45. A key container directory according to claim 44, wherein the key container has a datastore of cryptographic keys that can be contained in any provided key container.

46. A method of receiving a key container comprising the steps of:
sending a request to a key container directory for a key container to be used to secure a message that is transmitted from a sender to a recipient; and
receiving from the key container directory the key container that contains the cryptographic key of a gateway that the message will transit and an address of the sender or the recipient.

47. A method of receiving a key container according to claim 46, wherein the method is performed by the sender of the message.

48. A method of receiving a key container according to claim 46, wherein the step of sending a request for the key container includes an indication that an encryption key container is requested.

49. A method of receiving a key container according to claim 46, wherein the step of sending the request for the key container includes the address of the recipient.

50. A method of receiving a key container according to claim 46, wherein the method further comprises the step of encrypting the message using the cryptographic key contained in the key container.

51. A method of receiving a key container according to claim 46, wherein the key container is an encryption key container to be used for encryption operations.

52. A method of receiving a key container according to claim 46, wherein the key container contains a parameter that indicates that the key container is to be used for encryption functions.

53. A method of receiving a key container according to claim 46, wherein the key container secures the message through use of the cryptographic key to encrypt the message.

54. A method of receiving a key container according to claim 46, wherein the sender's address is from the same domain as the gateway.

55. A method of receiving a key container according to claim 46, wherein the method is performed by the gateway.

56. A method of receiving a key container according to claim 46, wherein the step of sending the request for the key container includes an indication that a signing key container is requested.

57. A method of receiving a key container according to claim 46, wherein the step of sending the request for the key container includes the address of the sender.

58. A method of receiving a key container according to claim 46, wherein the key container is a signing key container.

59. A method of receiving a key container according to claim 46, wherein the key container contains a parameter that indicates that the key container is to be used for signing operations.

60. A method of receiving a key container according to claim 46, wherein the key container secures the message by being carried with the message.

61. A method of receiving a key container according to claim 46, wherein the key container includes information that permits a requester to determine the authenticity and integrity of the key container.

62. A method of receiving a key container according to claim 46, wherein the key container contains security preferences of the gateway.

63. A method of receiving a key container according to claim 46, wherein the key container includes information about the key container directory that provided the key container.

64. An e-mail client that is operable to perform the method of receiving a key container according to claim 46.

65. A gateway that is operable to perform the method of receiving a key container according to claim 46.

66. A key container to be used to secure a message that is transmitted from a sender to a recipient using a gateway, wherein the key container contains a cryptographic key of the gateway, an address of the sender or the recipient and information that invalidates the use of the key container at a time in the future.

67. (canceled)

68. (canceled)

69. (canceled)
